(19) United States
(12) Patent Application Publication
(10) Pub. No.: US 2016/0146178 A1
(43) Pub. Date: May 26, 2016

(54) Hydroelectricity and Compressed-air Power Plant System

(71) Applicant: James Arthur Lowell, Charlotte, NC (US)

(72) Inventor: James Arthur Lowell, Charlotte, NC (US)

(21) Appl. No.: 14/550,011

(22) Filed: Nov. 21, 2014

(51) Int. Cl. F03B 13/24; H02K 7/18

(52) U.S. Cl. CPC F03B 13/24; H02K 7/1807

(57) ABSTRACT

A hydroelectricity and compressed-air power plant system includes a first fill pool, a plurality of internal fill tanks, an external fill tank, a wave channel, a plurality of air-generator units, a second fill pool, at least one air storage tank, and at least one generator system. The first fill pool is selectively in fluid communication with the external fill tank through the plurality of internal fill tanks while the external fill tank is selectively in fluid communication with the second fill pool through the wave channel. The second fill pool is selectively in fluid communication with the first fill pool through the at least one generator system so that a set amount of water can be circulated within the power plant system as it generates compressed-air from the plurality of air-generator units and electricity from the at least one generator system.

### FIELD OF THE INVENTION

The present invention relates generally to power generation. More specifically, a wave channel of the present invention collectively converts wave force of a water flow into compressed air while at least one generator system of the present invention creates hydroelectricity.

### BACKGROUND OF THE INVENTION

As technology and industry in the modern world continues to grow and expand, so do the power requirements. Many different sources of power generation exist today involving fossil fuel burning, solar, wind, geothermal, hydroelectric, wave and current power generation, etc. Hydroelectric and wave energy that use the movement of a water flow to generate electric power is considered to be one of the environmentally friendly methods of power generation. Hydroelectric generation normally accomplishes power generation through a dam and a plurality of hydro-turbines as the gravitational potential energy of the water retained by the dam is converted into electric energy by the plurality of hydro-turbines. Hydroelectricity is a valuable source of energy since it is renewable; it has a low cost and produces significantly less waste since it does not require hydrocarbons to be burned. The wave energy also produces a clean energy source as wave generators harness the marine waves to generate electricity.

It is therefore an objective of the present invention to provide an electricity generating system that combines hydro-turbines and wave generators in order to improve the efficiency of the hydroelectric generation. The present invention first utilizes the gravitational potential energy of a body of water to create wave energy so that compressed-air can be harnessed. Then the gravitational potential energy of the body of water is utilized to generate electric power. Additionally, the compressed-air generated from the wave generators is utilized to pneumatically control some components of the present invention and to pressurize the water flow that travels through the hydro-turbine.

### BRIEF DESCRIPTION OF THE DRAWINGS

FIG. 1 is a perspective view of the present invention.

FIG. 2 is a side view of the present invention, showing the different elevations of the first fill pool, the external fill tank, the wave channel, the second fill pool, the air storage tank, and the generator system.

FIG. 3 is a top view of the present invention, showing the plurality of air-generator units.

FIG. 4 is a side view of the present invention, showing the plan upon which a cross sectional view is taken shown in FIG. 5.

FIG. 5 is a cross sectional view of the present invention taken along line B-B of FIG. 4.

FIG. 6 is a partial side view of the present invention, showing detail views of the plurality of internal fill tanks, the external fill tank, and the wave channel with respect to the closed-position of the at least one top door, the pair of bottom doors, and pair of pair of release doors.

FIG. 7 is a partial side view of the present invention, showing detail views of the plurality of internal fill tanks, the external fill tank, and the wave channel with respect to the opened-position of the at least one top door, the pair of bottom doors, and pair of pair of release doors.

### DETAILED DESCRIPTIONS OF THE INVENTION

All illustrations of the drawings are for the purpose of describing selected versions of the present invention and are not intended to limit the scope of the present invention.

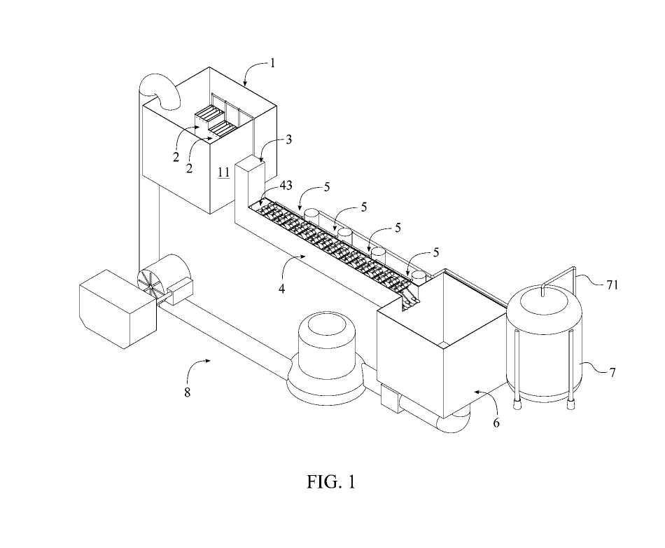

The present invention is a hydroelectricity and compressed-air power plant system that can be located in a remote area or near a water source. The present invention requires minimum amount of external energy to efficiently operate as a system; however, the present invention is able to generate large amounts of electricity and compressed-air as output energy. In reference to FIG. 1, the present invention comprises a first fill pool 1, a plurality of internal fill tanks 2, an external fill tank 3, a wave channel 4, a plurality of air-generator units 5, a second fill pool 6, at least one air storage tank 7, and at least one generator system 8. In reference to the general configuration of the present invention, the first fill pool 1 is selectively in fluid communication with the external fill tank 3 through the plurality of internal fill tanks 2 while the external fill tank 3 is selectively in fluid communication with the second fill pool 6 through the wave channel 4. The second fill pool 6 is selectively in fluid communication with the first fill pool 1 through the at least one generator system 8 so that a set amount of water can be circulated within the present invention. The plurality of air-generator units 5, which is connected along the wave channel 4, is selectively in fluid communication with the at least one air storage tank 7 through a collection pipe 71. The present invention uses the set amount of water that circulates within the system to generate compressed-air from the plurality of air-generator units 5 and electricity from the at least one generator system 8. The present invention also uses an external energy source within the at least one generator system 8 so that the present invention is efficiently and continuously able to generate electricity and compressed-air. Even though the present invention is explained in relation to the set amount of water that circulates within the system, the present invention can also function in conjunction with a water source such as a river, stream, waterfall, and canal.

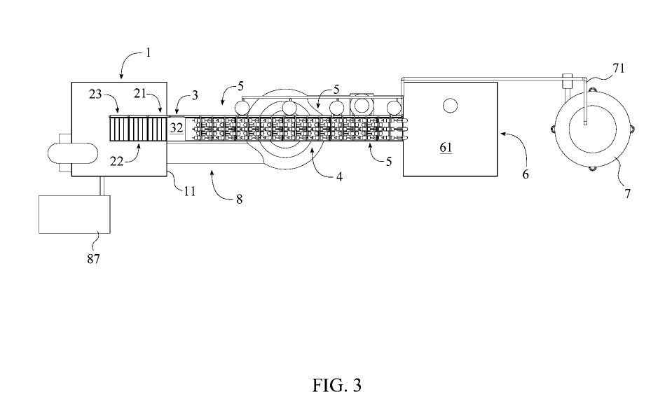

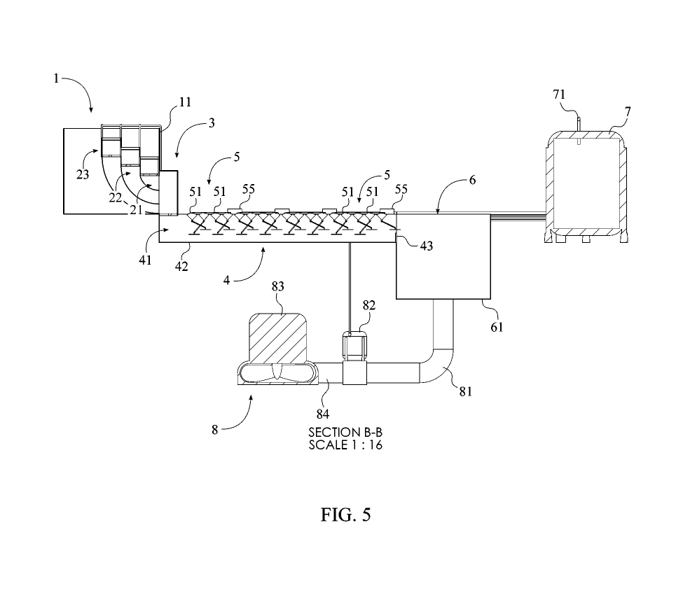

The first fill pool 1 retains a body of water that is required for the functionality of the present invention and functions as a platform for the plurality of internal fill tanks 2 and the external fill tank 3. In reference to FIG. 3, each of the plurality of internal fill tanks 2 is linearly positioned with each other within the first fill pool 1 in such a way that the each of the plurality of internal fill tanks 2 is connected to a front wall 11 of the first fill pool 1. In reference to FIG. 5, the external fill tank 3 is adjacently connected to the front wall 11 of the first fill pool 1 but oppositely positioned of the plurality of internal fill tanks 2. The plurality of internal fill tanks 2 is positioned below the water level of the first fill pool 1 and comprises a first fill tank 21, at least one second fill tank 22, and a third fill tank 23 within the preferred embodiment of the present invention. More specifically, the first fill tank 21 is connected to the first fill pool 1 and positioned opposite of the external fill tank 3. The first fill tank 21 is positioned offset from the external fill tank 3 in such a way that the first fill tank 21 is elevated above the external fill tank 3. The second fill tank 22 is adjacently connected to the first fill tank 21 and positioned opposite of the external fill tank 3. Additionally, the second fill tank 22 is positioned offset from the first fill tank 21, where the second fill tank 22 is elevated above the first fill tank 21. The third fill tank 23 is adjacently connected to the second fill tank 22 and positioned opposite of the first fill tank 21. In order to maintain the step-like configuration for the plurality of internal fill tanks 2, the third fill tank 23 is also positioned offset from the second fill tank 22 as the third fill tank 23 sits higher than the second fill tank 22.

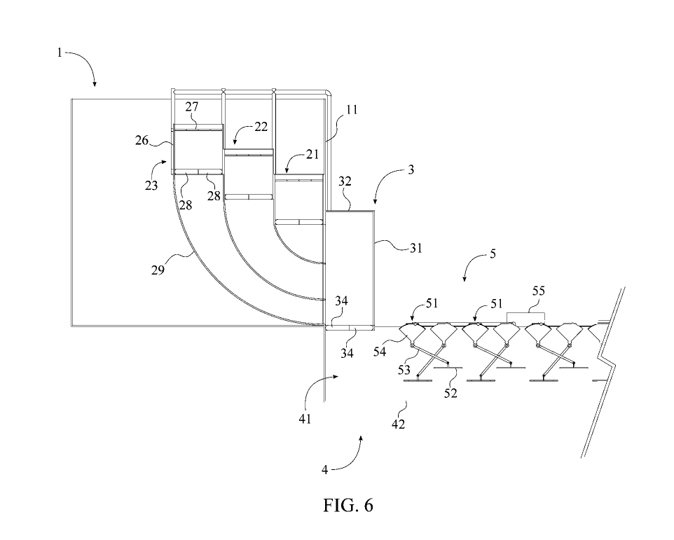

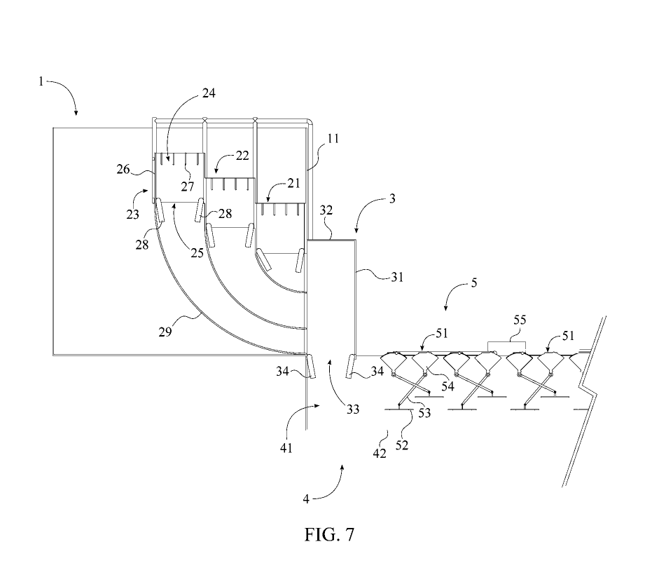

Since the first fill pool 1 is selectively in fluid communication with the external fill tank 3 through the plurality of internal tanks, each of the plurality of internal fill tanks 2 is sequentially filled with water as the required amount of water is drained from the first fill pool 1. More specifically, each of the plurality of internal fill tanks 2 comprises a top opening 24, a bottom opening 25, a tubular body 26, at least one top door 27, a pair of bottom doors 28, and a release channel 29 as shown in FIG. 6 and FIG. 7. The top opening 24 and the bottom opening 25 are oppositely positioned of each other across the tubular body 26, wherein the top opening 24 allows the required amount of water to drain from the first fill pool 1 and into the tubular body 26. The at least one top door 27 that controls the amount of water drained into the tubular body 26 is internally connected to the tubular body 26 adjacent to the top opening 24. The at least one top door 27 is pneumatically connected with the at least one air storage tank 7 so that the compressed-air from the at least one air storage tank 7 is able to operate the at least one top door 27 according to the system specification. Due to the configuration of the top opening 24 and the at least one top door 27, the top opening 24 is selectively in fluid communication with the first fill pool 1 through the at least one top door 27. The pair of bottom doors 28 is internally connected to the tubular body 26 and positioned adjacent to the bottom opening 25 as the bottom opening 25 discharges the stored water within the tubular body 26 into the external fill tank 3. Similar to the at least one top door 27, the pair of bottom doors 28 is also pneumatically connected with the at least one air storage tank 7 so that the compressed-air from the at least one air storage tank 7 is able to operate the pair of bottom doors 28 according to the system specification. The release channel 29 that directs the discharged water from the tubular body 26 is connected to the tubular body 26 adjacent to the bottom opening 25 and oppositely positioned of the top opening 24. The release channel 29 traverses into the external fill tank 3 through the front wall 11 of the first fill pool 1 so that the release channel 29 can be selectively in fluid communication with the external fill tank 3 through the pair of bottom doors 28.

When each of the plurality of internal fill tanks 2 needs to be filled with the required amount of water, the at least one top door 27 for each of the plurality of internal fill tanks 2 remains in the opened-position while the pair of bottom doors 28 remain in the closed-position. As a result, the water within the first fill pool 1 is drained into the respective internal fill tank through the top opening 24 and contained within tubular body 26. Once the required amount of water is drained into the tubular body 26, the at least one top door 27 is changed into the closed-position within the first fill pool 1 so that the water draining process can be stopped. Then the water within the tubular body 26 is discharged into the release channel 29 through the bottom opening 25 as the pair of bottom doors 28 changes from the closed-position to the opened-position. Then the discharged water from the tubular body 26 is able to flow into the external fill tank 3 through the release channel 29. In order maximize the efficiency of the present invention, the at least one top door 27 and the pair of bottom doors 28 for each of the plurality of internal fill tanks 2 are switched in between the opened-position and the closed-position in a systematic manner so that the required amount of water can be released into the external fill tank 3 with optimal time intervals.

In reference to FIG. 6 and FIG. 7, the external fill tank 3 that collects the required amount of water from each of the plurality of internal fill tanks 2 comprises a tubular member 31, a top surface 32, an outlet 33, and a pair of release doors 34. The outlet 33 and the top surface 32 are oppositely positioned from each other across the tubular member 31 as the pair of release doors 34 is internally connected to the tubular member 31 adjacent to the outlet 33. The outlet 33 is selectively in fluid communication with a channel opening 41 of the wave channel 4 so that the water contained within the external fill tank 3 can be released into the wave channel 4. The pair of release doors 34 controls how long the required amount of water is contained with the external fill tank 3 and the exact time interval that the required amount of water is released into the channel opening 41 as the pair of release doors 34 is pneumatically connected with the at least one air storage tank 7. Due to the pneumatic connection of the pair of release doors 34, the compressed-air from the at least one air storage tank 7 is able to operate the pair of release doors 34 according to the system specification. For example, when the pair of release doors 34 is at the closed-position, the required amount of water is contained within the external fill tank 3. However, when the pair of release doors 34 is switched into the opened-position from the closed-position, the required amount of water is released into the wave channel 4.

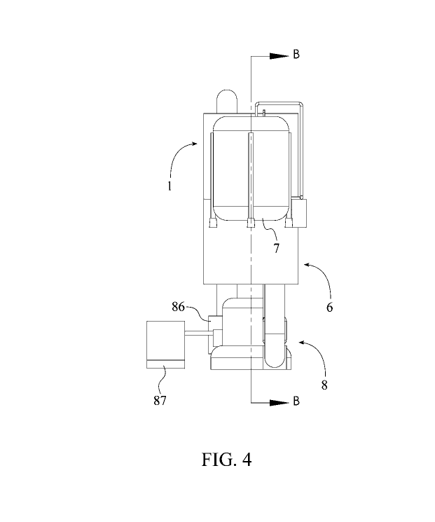

In reference to FIG. 4 and FIG. 5, the wave channel 4 that enables the fluid communication between the first fill pool 1 and the second fill pool 6 comprises a channel base 42 and a weir 43 in addition to the channel opening 41 that extends along the channel base 42. The second fill pool 6 is connected to the wave channel 4 and positioned opposite of the first fill pool 1 across the channel base 42 so that the water released from the external fill tank 3 is able to travel down the wave channel 4 and flow into the second fill pool 6. More specifically, the weir 43 is positioned in between the channel base 42 and the second fill pool 6 and connected to the channel base 42 and the second fill pool 6. The weir 43 creates a barrier in between the wave channel 4 and the second fill pool 6 so that the wave channel 4 is always able to retain some amount of water within the channel base 42. The channel base 42 is also positioned atop the a bottom surface 61 of the second fill pool 6, resulting a top edge of the wave channel 4 to be elevated up to a top edge of the second fill pool 6. Once the external fill tank 3 releases the required amount of water into the wave channel 4, the water released from the external fill tank 3 and the water retaining within the channel base 42 create a plurality of waves within the wave channel 4. The wave trough and wave crest of the plurality of waves then force the body of water to travel along the length of the wave channel 4. Once the plurality of waves reaches the weir 43 and the second fill tank 22, the excess amount of water that rests above the weir 43 is drained into the second fill pool 6. Since the external fill pool intermittently releases the required amount of water into the wave channel 4, the wave channel 4 is continuously able to maintain the plurality of waves that travels along the length of the wave channel 4.

In reference to FIG. 3, FIG. 6, and FIG. 7, the plurality of waves created by the external fill tank 3 and the wave channel 4 is utilized by the plurality of air-generator units 5 as each of the plurality of air-generator units 5 is positioned along the wave channel 4. Each of the plurality of air-generator units 5 comprises a plurality of wave generators 51 and a collection tank 55, wherein the plurality of wave generators 51 is in fluid communication with the collection tank 55. Each of the plurality of wave generators 51 comprises a wave paddle 52, a leaver, and an air pump 54. The air pump 54, which produces the compressed-air required for the pneumatically operated components of the present invention, is connected to the channel base 42 and adjacently positioned with the channel opening 41 so that the air pump 54 is able to position above the plurality of waves of the wave channel 4. The lever 53 is operatively coupled with the air pump 54 from an end as the lever 53 is able to operate the air pump 54 through the wave paddle 52. More specifically, the wave paddle 52 is hingedly connected to the lever 53 opposite of the air pump 54 and positioned within the channel base 42. Additionally, the wave paddle 52 is made as a flotation device so that the wave paddle 52 floats according to the water level of the wave channel 4. The lever 53 is pivotably connected to the channel base 42 between the air pump 54 and the wave paddle 52 so that upward and downward movement of the wave paddle 52 is able move the lever 53 which subsequently powers the air pump 54. For example, when the plurality of waves is not present within the present invention, the wave paddle 52 just floats within the wave channel 4 without any upward and downward movements. However, when the plurality of waves travels down the wave channel 4, the wave crest of the plurality of waves vertically moves the wave paddle 52 up toward the channel opening 41 creating upward movement. Then the wave trough of the plurality of waves is able to vertically move down the wave paddle 52 towards the bottom surface of the channel base 42 creating downward movement. The constant upward and downward movement of the wave paddle 52 is able to continuously power the air pump 54 so that air pump 54 can produce the compressed-air required for the present invention. The air pump 54 of each of the plurality of wave generators 51 is individually in fluid communication with the collection tank 55 as the collection tank 55 temporally stores the compressed-air generated from the air pump 54. The collection tank 55 is also in fluid communication with the collection pipe 71 in order to complete each of the plurality of air-generator units 5. As a result of the in fluid communication of the collection tank 55 and the collection pipe 71, the compressed-air collected within the collection tank 55 can be easily discharged into the at least one air storage tank 7 through the collection pipe 71.

In reference to FIG. 1-3, the at least one generator system 8 generates the hydroelectricity within the present invention and is in fluid communication from the second fill pool 6 to the first fill pool 1. In other words, the water has to be traveled from the second fill pool 6, through the at least one generator system 8, and into the first fill pool 1 so that the present invention is able to produce hydroelectricity. The at least one generator system 8 comprises a main discharge pipe 81, an air compressor unit 82, a hydro-turbine unit 83, a pump 86, an external power source 87, and a return pipe 88. The air compressor unit 82 is in fluid communication with the second fill pool 6 through the main discharge pipe 81 so that the air compressor unit 82 is able to receive a flow of water from the second fill pool 6. Since the second fill pool 6 retains a body of water and also receives water from the wave channel 4, the second fill pool 6 contains a sufficient volume of water so that the air compressor is able to receive a constant flow of water through the main discharge pipe 81. In order to maximize the volumetric flow rate of the water flow, the main discharge pipe 81 is preferably positioned adjacent to the bottom surface 61 of the second fill pool 6. Additionally, the second fill pool 6 is also positioned atop the air compressor unit 82 to maximize the gravitational potential energy of the body of water that is retained within the second fill pool 6. The air compressor unit 82 is also in fluid communication with the at least one air storage tank 7 so that the compressed-air can be supplied to the air compressor unit 82. Then the compressed-air within the air compressor unit 82 is introduced into the constant flow of water so that the compressed-air is able to pressurize the water flow while increasing the volumetric flow rate.

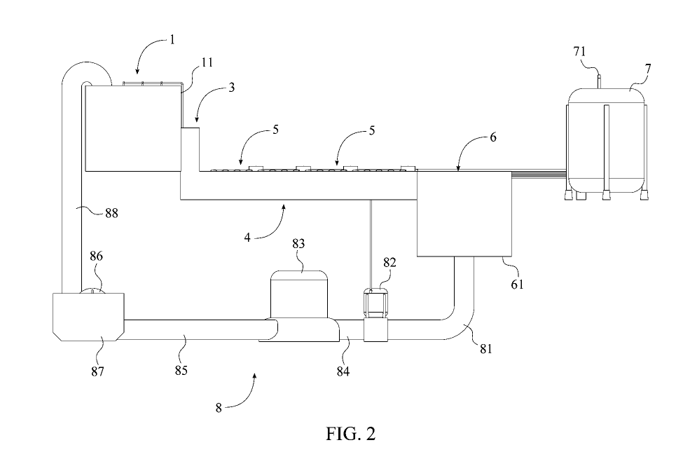

In reference to FIG. 2, the pump 86 is in fluid communication with the air compressor unit 82 through the hydro-turbine unit 83. More specifically, the hydro-turbine unit 83 is in fluid communication with the air compressor unit 82 through a turbine inlet pipe 84 of the hydro-turbine so that the pressurized water flow from the air compressor unit 82 can be discharged into the hydro-turbine unit 83. Then the pressurized water flow is able to rotate the rotor components of the hydro-turbine unit 83 and exits into a turbine outlet pipe 85 of the hydro-turbine. The turbine outlet pipe 85 and the turbine inlet pipe 84 are oppositely positioned from each other across the hydro-turbine unit 83 to maximize the volumetric flow rate of the pressurized water flow. The pump 86 is in fluid communication with the hydro-turbine unit 83 through the turbine outlet pipe 85, and the first fill pool 1 is in fluid communication with the pump 86 through the return pipe 88. The pump 86 receives the exit water flow from the hydro-turbine unit 83 through the turbine outlet pipe 85 so that the pump 86 is able to propel the exit water flow back into the first fill pool 1 through the return pipe 88. The pump 86 is electrically connected with the external power source 87 so that the external power source 87 is able to provide the necessary energy for the pump 86. The external power source 87 can include, but is not limited to, a diesel generator and natural gas generator.

Although the invention has been explained in relation to its preferred embodiment, it is to be understood that many other possible modifications and variations can be made without departing from the spirit and scope of the invention as hereinafter claimed.

What is claimed is:

1. A hydroelectricity and compressed-air power plant system comprises:
a first fill pool;
a plurality of internal fill tanks;
an external fill tank;
a wave channel;
a plurality of air-generator units;
a second fill pool;
at least one air storage tank;
at least one generator system;
the first fill pool being selectively in fluid communication with the external fill tank through the plurality of internal fill tanks;
the external fill tank being selectively in fluid communication with the second fill pool through the wave channel;
the plurality of air-generator units being connected along the wave channel;
the plurality of air-generator units being selectively in fluid communication with the at least one air storage tank though a collection pipe; and
the second fill pool being selectively in fluid communication with the first fill pool through the at least one generator system.

2. The hydroelectricity and compressed-air power plant system as claimed in claim 1 comprises:
each of the plurality of internal fill tanks being linearly positioned with each other within the first fill pool;
each of the plurality of internal fill tanks being connected to a front wall of the first fill pool; and
the external fill tank being adjacently connected to the front wall of the first fill pool opposite of the plurality of internal fill tanks.

3. The hydroelectricity and compressed-air power plant system as claimed in claim 1 comprises;
the plurality of internal fill tanks comprises a first fill tank, at least one second fill tank, and a third fill tank;
the first fill tank being connected to the first fill pool opposite of the external fill tank;
the first fill tank being offset from the external fill tank;
the second fill tank being adjacently connected to the first fill tank opposite of the external fill tank;
the second fill tank being offset from the first fill tank;
the third fill tank being adjacently connected to the second fill tank opposite of the first fill tank; and
the third fill tank being offset from the second fill tank.

4. The hydroelectricity and compressed-air power plant system as claimed in claim 1 comprises;
each of the plurality of internal fill tanks comprises a top opening, a bottom opening, a tubular body, at least one top door, a pair of bottom doors, and a release channel;
the top opening and the bottom opening being oppositely positioned of each other across the tubular body;
the at least one top door being internally connected to the tubular body adjacent to the top opening;
the at least one top door being pneumatically connected with the at least one air storage tank, wherein the compressed-air from the at least one air storage tank operates the at least one top door;
the top opening being selectively in fluid communication with the first fill pool through the at least one top door;
the pair of bottom doors being internally connected to the tubular body adjacent to the bottom opening;
the pair of bottom doors being pneumatically connected with the at least one air storage tank, wherein the compressed-air from the at least one air storage tank operates the pair of bottom doors;
the release channel being connected to the tubular body adjacent to the bottom opening;
the release channel being oppositely positioned of the top opening;
the release channel traversing into the external fill tank through a front wall the first fill pool; and
the release channel being selectively in fluid communication with the external fill tank through the pair of bottom doors.

5. The hydroelectricity and compressed-air power plant system as claimed in claim 1 comprises:
the external fill tank comprises a tubular member, a top surface, an outlet, and a pair of release doors;
the outlet and the top surface being oppositely positioned from each other across the tubular member;
the pair of release doors being internally connected to the tubular member adjacent to the outlet;
the pair of release doors being pneumatically connected with the at least one air storage tank, wherein the compressed-air from the at least one air storage tank operates the pair of release doors; and
the outlet being selectively in fluid communication with a channel opening of the wave channel through the pair of release doors.

6. The hydroelectricity and compressed-air power plant system as claimed in claim 1 comprises:
the wave channel comprises a channel base, a channel opening, and a weir;
the channel opening being extended along the channel base;
the second fill pool being connected to the wave channel and oppositely positioned from the first fill pool across the channel base;
the weir is positioned in between the channel base and the second fill pool;
the weir is connected to the channel base and the second fill pool;
the channel base being positioned atop a bottom surface of the second fill pool; and
the wave channel being in fluid communication with the second fill pool adjacent to the weir.

7. The hydroelectricity and compressed-air power plant system as claimed in claim 1 comprises:
each of the plurality of air-generator units comprises a plurality of wave generators and a collection tank;
each of the plurality of wave generators comprises a wave paddle, a lever, and an air pump;
the air pump being connected to a channel base of the wave channel and adjacently positioned with a channel opening of the wave channel;
the lever being operatively coupled with the air pump, wherein the air pump produces compressed-air;
the wave paddle being hingedly connected to the lever opposite of the air pump;
the wave paddle being positioned within channel base;
the lever being pivotably connected to the channel base in between the air pump and the wave paddle;
the air pump of each of the plurality of wave generators being in fluid communication with the collection tank, wherein the collection tank temporally stores compressed-air from the air pump; and
the collection tank being selectively in fluid communication with the collection pipe, wherein the collection pipe supplies compressed-air from the collection tank to the at least one air storage tank.

8. The hydroelectricity and compressed-air power plant system as claimed in claim 1 comprises:
the at least one generator system comprises a main discharge pipe, an air compressor unit, a hydro-turbine unit, a pump, an external power source, and a return pipe;
the air compressor unit being in fluid communication with the second fill pool through the main discharge pipe;
the second fill pool being positioned atop the air compressor unit;
the air compressor unit being in fluid communication with the at least one air storage tank, wherein the compressed-air from the at least one air storage tank is supplied to the air compressor unit;
the hydro-turbine unit being in fluid communication with the air compressor unit through a turbine inlet pipe of the hydro-turbine unit;
the pump being in fluid communication with the hydro-turbine unit through a turbine outlet pipe of the hydro-turbine unit;
the turbine inlet pipe and the turbine outlet pipe being oppositely positioned from each other across the hydro-turbine unit; and
the first fill pool being in fluid communication with the pump through the return pipe.

9. The hydroelectricity and compressed-air power plant system as claimed in claim 8 comprises:
the pump being electrically connected with the external power source.

10. A hydroelectricity and compressed-air power plant system comprises:
a first fill pool;
a plurality of internal fill tanks;
an external fill tank;
a wave channel;
a plurality of air-generator units;
a second fill pool;
at least one air storage tank;
at least one generator system;
the at least one generator system comprises a main discharge pipe, an air compressor unit, a hydro-turbine unit, a pump, an external power source, and a return pipe;
the first fill pool being selectively in fluid communication with the external fill tank through the plurality of internal fill tanks;
the external fill tank being selectively in fluid communication with the second fill pool through the wave channel;
the plurality of air-generator units being connected along the wave channel;
the plurality of air-generator units being selectively in fluid communication with the at least one air storage tank though a collection pipe;
the second fill pool being selectively in fluid communication with the first fill pool through the at least one generator system;
the air compressor unit being in fluid communication with the second fill pool through the main discharge pipe;
the air compressor unit being in fluid communication with the at least one air storage tank, wherein the compressed-air from the at least one air storage tank is supplied to the air compressor unit;
the pump being in fluid communication with the air compressor unit through the hydro-turbine unit; and
the first fill pool being in fluid communication with the pump through the return pipe.

11. The hydroelectricity and compressed-air power plant system as claimed in claim 10 comprises:
each of the plurality of internal fill tanks being linearly positioned with each other within the first fill pool;
each of the plurality of internal fill tanks being connected to a front wall of the first fill pool; and
the external fill tank being adjacently connected to the front wall of the first fill pool opposite of the plurality of internal fill tanks.

12. The hydroelectricity and compressed-air power plant system as claimed in claim 10 comprises;
the plurality of internal fill tanks comprises a first fill tank, at least one second fill tank, and a third fill tank;
the first fill tank being connected to the first fill pool opposite of the external fill tank;
the first fill tank being offset from the external fill tank;
the second fill tank being adjacently connected to the first fill tank opposite of the external fill tank;
the second fill tank being offset from the first fill tank;
the third fill tank being adjacently connected to the second fill tank opposite of the first fill tank; and
the third fill tank being offset from the second fill tank.

13. The hydroelectricity and compressed-air power plant system as claimed in claim 10 comprises;
each of the plurality of internal fill tanks comprises a top opening, a bottom opening, a tubular body, at least one top door, a pair of bottom doors, and a release channel;
the top opening and the bottom opening being oppositely positioned of each other across the tubular body;
the at least one top door being internally connected to the tubular body adjacent to the top opening;
the at least one top door being pneumatically connected with the at least one air storage tank, wherein the compressed-air from the at least one air storage tank operates the at least one top door;
the top opening being selectively in fluid communication with the first fill pool through the at least one top door;
the pair of bottom doors being internally connected to the tubular body adjacent to the bottom opening;
the pair of bottom doors being pneumatically connected with the at least one air storage tank, wherein the compressed-air from the at least one air storage tank operates the pair of bottom doors;
the release channel being connected to the tubular body adjacent to the bottom opening;
the release channel being oppositely positioned of the top opening;
the release channel traversing into the external fill tank through a front wall the first fill pool; and
the release channel being selectively in fluid communication with the external fill tank through the pair of bottom doors.

14. The hydroelectricity and compressed-air power plant system as claimed in claim 10 comprises:
the external fill tank comprises a tubular member, a top surface, an outlet, and a pair of release doors;
the outlet and the top surface being oppositely positioned from each other across the tubular member;
the pair of release doors being internally connected to the tubular member adjacent to the outlet;
the pair of release doors being pneumatically connected with the at least one air storage tank, wherein the compressed-air from the at least one air storage tank operates the pair of release doors; and
the outlet being selectively in fluid communication with a channel opening of the wave channel through the pair of release doors.

15. The hydroelectricity and compressed-air power plant system as claimed in claim 10 comprises:
the wave channel comprises a channel base, a channel opening, and a weir;
the channel opening being extended along the channel base;
the second fill pool being connected to the wave channel and oppositely positioned from the first fill pool across the channel base;
the weir is positioned in between the channel base and the second fill pool;
the weir is connected to the channel base and the second fill pool;
the channel base being positioned atop a bottom surface of the second fill pool; and
the wave channel being in fluid communication with the second fill pool adjacent to the weir.

16. The hydroelectricity and compressed-air power plant system as claimed in claim 10 comprises:
each of the plurality of air-generator units comprises a plurality of wave generators and a collection tank;
each of the plurality of wave generators comprises a wave paddle, a lever, and an air pump;
the air pump being connected to a channel base of the wave channel and adjacently positioned with a channel opening of the wave channel;
the lever being operatively coupled with the air pump, wherein the air pump produces compressed-air;
the wave paddle being hingedly connected to the lever opposite of the air pump;
the wave paddle being positioned within channel base;
the lever being pivotably connected to the channel base in between the air pump and the wave paddle;
the air pump of each of the plurality of wave generators being in fluid communication with the collection tank, wherein the collection tank temporally stores compressed-air from the air pump; and
the collection tank being selectively in fluid communication with the collection pipe, wherein the collection pipe supplies compressed-air from the collection tank to the at least one air storage tank.

17. The hydroelectricity and compressed-air power plant system as claimed in claim 10 comprises:
the second fill pool being positioned atop the air compressor unit;
the hydro-turbine unit being in fluid communication with the air compressor unit through a turbine inlet pipe of the hydro-turbine unit;
the pump being in fluid communication with the hydro-turbine unit through a turbine outlet pipe of the hydro-turbine unit; and
the turbine inlet pipe and the turbine outlet pipe being oppositely positioned from each other across the hydro-turbine unit.

18. The hydroelectricity and compressed-air power plant system as claimed in claim 10 comprises:
the pump being electrically connected with the external power source.
